(19) United States
(12) Patent Application Publication
(10) Pub. No.: US 2024/0109319 A1
(43) Pub. Date: Apr. 4, 2024

(54) OVERMOLDED PANEL OF PRINTHEAD HAVING WIDE SLOTS

(71) Applicant: Hewlett-Packard Development Company, L.P., Spring, TX (US)

(72) Inventors: Samuel Timothy Herro Brannon, Corvallis, OR (US); Bo Song, Corvallis, OR (US)

(21) Appl. No.: 17/959,766

(22) Filed: Oct. 4, 2022

(51) Int. Cl. B41J 2/14; B41J 2/16

(52) U.S. Cl. CPC B41J 2/1433; B41J 2/162; B41J 2/1637

(57) ABSTRACT

A printhead includes one or multiple printhead dies and an overmolded panel around the printhead dies. The printhead dies are each to eject a corresponding type of fluid. The overmolded panel has one or multiple wide slots respectively corresponding to the printhead dies. Each wide slot is to supply fluid of the corresponding type to the printhead die to which the wide slot corresponds.

### BACKGROUND

Fluid-ejection devices eject fluid, such as onto media. For example, one type of fluid-ejection device is an inkjet-printing device, which ejects ink onto media like paper to form an image on the media. A fluid-ejection device can have one or multiple fluid-ejection printheads that eject fluid. A printhead may be a removable or integrated part of a printhead assembly that also includes a supply of fluid, or the printhead may be fluidically connectable to an external fluid supply.

### BRIEF DESCRIPTION OF THE DRAWINGS

FIG. 1 is a cross-sectional front view diagram of an example printhead having a wide-slot overmolded panel around a single printhead die.

FIG. 2 is a flowchart of an example method for fabricating printheads that each have a wide-slot overmolded panel around one or multiple printhead dies.

FIG. 3A is a top view diagram of an example carrier populated with printhead dies, and FIG. 3B is a cross-sectional front view diagram of three such printhead dies on the carrier.

FIG. 4 is a cross-sectional front view diagram of example molding compound overmolded around three printhead dies on a carrier with a mold chase forcibly clamped to the dies.

FIG. 5A is a top view diagram of example wide-slot overmolded panels around printhead dies that are segmented in correspondence with individual printheads, and FIG. 5B is a cross-sectional front view diagram of one such example printhead.

FIGS. 6A, 6B, 6C, 6D, 6E and 6F are top-view diagrams of an example printhead having a wide-slot overmolded panel around three printhead dies, according to different slot configurations.

### DETAILED DESCRIPTION

As noted in the background, a printhead can include one or multiple printhead dies that eject fluid. A printhead die can include firing elements, fluid chambers, and fluid-ejection nozzles. Activation of one or multiple firing elements causes fluid to be ejected from a corresponding chamber through one or multiple corresponding nozzles. The firing elements may be thermal resistors, for instance, or piezoelectric elements. Fluid enters and exits the chambers through corresponding fluid channels fluidically coupled to the chambers.

A printhead can include a panel around the printhead die or dies of the printhead. For each printhead die, the panel has one or multiple corresponding fluid slots. The fluid slots are fluidically connected to the channels of their respective printhead dies. Therefore, the fluid slots provide fluid to and receive fluid from the chambers of the dies via the fluid channels. For example, the slots can replenish the chambers as fluid is ejected from the chambers. As another example, fluid can be recirculated from the fluid slots through the chambers or other portions of the printhead die even when the fluid is not being ejected.

A panel can be overmolded around one or multiple printhead dies so as to form the fluid slots adjacent to the dies. A carrier may be populated with a number of printhead dies for multiple printheads. A mold chase having slot feature inserts is moved towards the carrier until the inserts are forcibly clamped to the dies. Molding compound is then overmolded around the dies, forming the panels. The slot feature inserts define the width of the panel slots, since the compound is not molded onto the printhead dies where the inserts are clamped onto the dies.

After molding, the mold chase is moved away from the carrier, and the carrier is removed from the printhead dies with the overmolded panels. The panels are then segmented in correspondence with individual printheads. Each printhead includes a panel and one or multiple printhead dies. For example, a color printhead may have three dies corresponding to cyan, magenta, and yellow ink, with one or more slots in the panel for each die. As another example, a monochrome printhead may have a single die corresponding to black (or another color of) ink, with one or more slots in the panel for the die. More generally, each die is to eject a corresponding type (e.g., color) of fluid, and each slot is to supply the fluid of the corresponding type to a corresponding die.

Printhead dies have become more narrow. Dies have become smaller in width to improve image quality, so that adjacent printheads are located closer to one another. Dies have also become larger in length. In the case of scanning printheads, in which a printhead ejects fluid onto media as the printhead is scanned laterally across the media, a longer die permits ejection of fluid over a larger swath of the media at a time, increasing speed and/or quality. In the case of page-wide printhead arrays, in which an array of printheads is stationarily positioned along the width of the media while ejecting fluid, longer dies mean that fewer are needed for an array of given page width.

However, as printhead dies have become more narrow, overmolding panels around the dies has become more difficult, requiring more precise positioning of the slot feature inserts of the molding chase in relation to the dies. If the slot feature inserts are sufficiently off-center and thus sufficiently misaligned when clamped against the dies, the inserts may tilt the dies upwards from the carrier. This can lead to a number of issues. For instance, molding compound may enter between the insert and a printhead die or between the die and the carrier, which can result in an inoperative printhead.

Furthermore, even if the printhead is not inoperative, the die may be sufficiently tilted that it affects subsequent validation and testing of the printhead. For example, printhead validation and testing can involve machine vision to identify and inspect the die on the printhead. If the die is sufficiently tilted, the machine vision may fail to identify the die, resulting in the printhead failing inspection and being rejected. Finally, even if the printhead is not inoperative and is not rejected, the tilted die can result in suboptimal fluid ejection, thus affecting image quality.

Techniques described herein resolve these and other issues associated with a printhead having an overmolded panel around one or multiple printhead dies. Specifically, the fluid slots within the panel overmolded onto the dies are widened. By defining, specifying, or corresponding to wide slots, the slot feature inserts of the molding chase are less likely to tilt the dies away from the carrier when the insert is forcibly clamped against the dies. A wide slot may be defined as a slot having a maximal width that is at least 70% of the width of the printhead die, and even greater than 100% of die width.

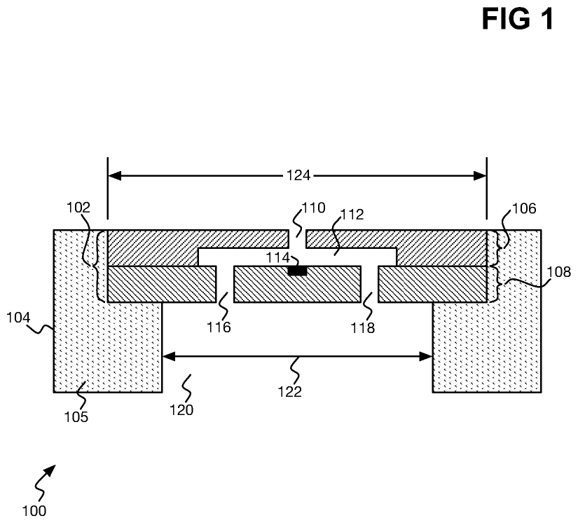

FIG. 1 shows a cross-sectional front view of an example printhead 100. The printhead 100 includes a printhead die 102 and an overmolded panel 104 around the die 102. The panel 104 is fabricated from molding compound 105, such as epoxy molding compound. The die 102 includes a nozzle layer 106, which may also be referred to a nozzle plate, and a device layer 108, which may also be referred to as a channel layer. The nozzle layer 106 may be fabricated from a relatively soft material, such as SU-8 epoxy negative photoresist. The device layer 108 may be fabricated from silicon or another semiconductor substrate material. Each of the layers 106 and 108 may be an integrated layer, or multiple stacked layers.

The printhead die 102 includes a fluid-ejection nozzle 110 and a fluid chamber 112 in the nozzle layer 106, and fluid channels 116 and 118 and a firing element 114 in the device layer 108. The nozzle 110 is directly fluidically coupled to the chamber 112, which is directly fluidically coupled to the channels 116 and 118. The element 114 is formed at the bottom of the chamber 112. There may be more than one nozzle 110 directly fluidically coupled to and/or more than one element 114 formed at the bottom of the chamber 112. As depicted, the nozzle 110 is centered in the chamber, as is the element 114, but in other implementations either or both may be off-center.

The overmolded panel 104 includes a wide slot 120 that has a maximal width 122. The maximal width 122 of the slot 120 can be defined as the width of the slot 120 at its widest point where the slot 120 is adjacent to the device layer 108. For example, the slot 120 may have one or multiple fluidically connected or separate portions of varying widths. The width of the widest slot portion where it is adjacent to the device layer 108 is the maximal width 122 of the slot 120. The slot 120 may be considered a wide slot in that its maximal width 122 can be at least 70, and even greater than 90 or 100% of the width 124 of the printhead die 102.

The wide slot 120 of the overmolded panel 104 is directly fluidically connected to the fluid channels 116 and 118 of the printhead die 102. In operation, the slot 120 supplies fluid to the fluid chamber 112 of the die 102 via the channels 116 and 118. Activation of the firing element 114, such as a thermal resistor, causes a fluid droplet to be ejected from the fluid-ejection nozzle 110 of the die 102. Other fluid within the chamber 112 may be momentarily expelled back into the slot 120 via the channels 116 and 118, through which the slot 120 then replenishes the chamber 112 with fluid.

In one implementation, fluid may be continuously recirculated inwards from the fluid slot 120 through the fluid channel 116 (or 118), through the fluid chamber 112, and outwards to the slot 120 through the fluid channel 118 (or 116). There may be a rib extending partially but not completely into the slot 120 at the bottom of the device layer 108 of the printhead die 102 in this implementation. The rib ensures that fluid exiting the channel 118 (or 116) does not immediately reenter the channel 116 (or 118) for recirculation back through the chamber 112.

The printhead die 102 in actuality includes multiple fluid chambers 112 proceeding inwards into the plane of the figure. Each chamber 112 has its own set of fluid channels 116 and 118, one or multiple firing elements 114, and one or multiple fluid-ejection nozzles 110. In the case in which each chamber 112 has a single nozzle 110, there may be 336 nozzles 110 in the die 102, for instance. Each chamber 112 is fluidically isolated from every other chamber 112 within the die 102 itself. However, each chamber 112 is fluidically connected to the slot 120 via its channels 116 and 118.

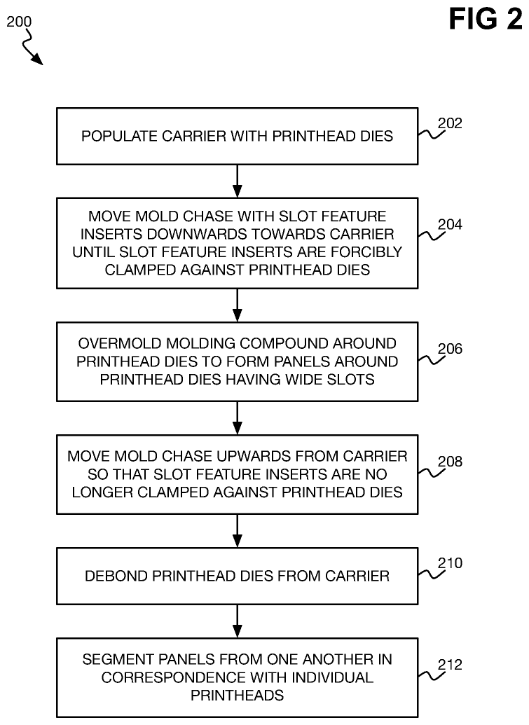

FIG. 2 shows an example method 200 for fabricating printheads with wide slots. First, a carrier is populated within multiple printhead dies 102 (202). The dies 102 are placed in the carrier facedown. That is, the nozzle layers 106 of the dies 102 are at the bottom of the carrier, and the device layers 108 of the dies 102 exposed at the top of the carrier.

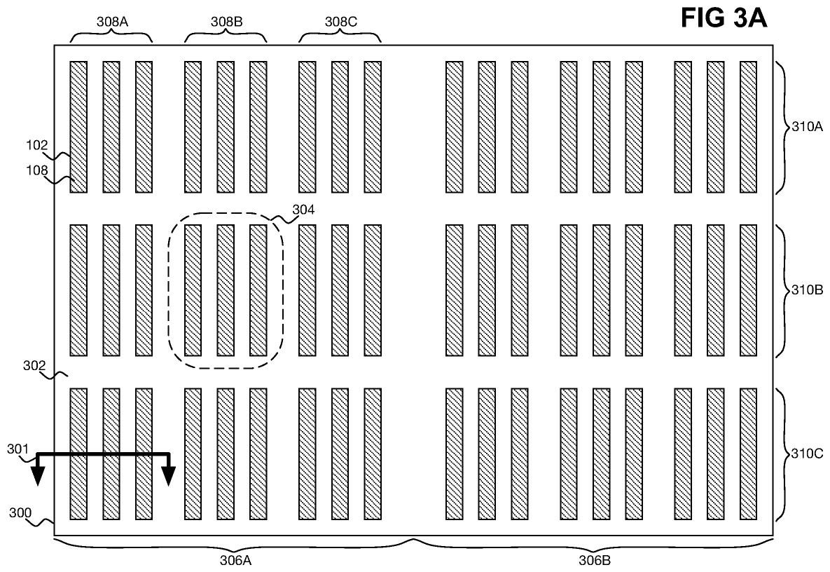

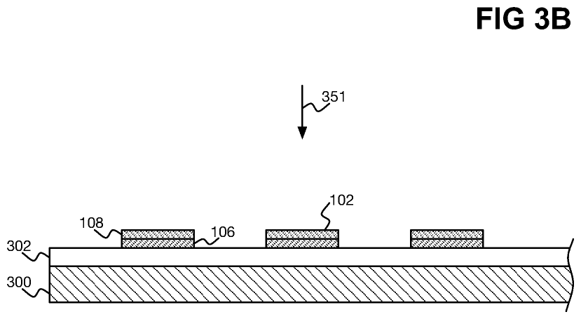

FIG. 3A shows a top view of an example carrier 300 populated with printhead dies 102, and FIG. 3B shows a cross-sectional front view of a portion of the carrier 300. The cross-sectional front view of FIG. 3B is at the cross-sectional line 301 in FIG. 3A. The top view of FIG. 3A is indicated by the arrow 351 in FIG. 3B.

The carrier 300 includes release tape 302 on which the dies 102 are placed, which aids in subsequent removal of the dies 102 from the carrier 300. The dies 102 are placed facedown with their nozzle layers 106 against the tape 302, such that their device layers 108 are exposed at the top of the carrier 300. In the example, the printhead dies 102 are placed on the carrier 300 in distanced groups 304 of three dies 102. Each group 304 of three dies 102 corresponds to a separate printhead. More generally, each group 304 includes one or multiple printhead dies 102.

The printhead die groups 304 may be organized be organized in distanced left and right sections 306A and 306B, as depicted. As also depicted, in each section 306A and 306B, the die groups 304 may be organized over three columns 308A, 308B and 308C and three rows 310A, 310B, and 310C. However, the groups 304 may be organized in fewer or more than two sections, fewer or more than three columns, and/or fewer or more than three row.

Referring back to FIG. 2, a mold chase with slot feature inserts is moved downwards toward the carrier 300 until the slot feature inserts are forcibly clamped against the printhead dies 102 within the carrier 300 (204). While the inserts are so forcibly clamped, molding compound 105, such as epoxy molding compound, is then overmolded around the dies 102 to form panels 104 around the dies 102 (206). Molding compound 105 is not molded onto the dies 102 where the slot feature inserts are. Therefore, slots 120 are formed in the panels 104 at maximal widths 122 defined by the inserts to form the panel 104.

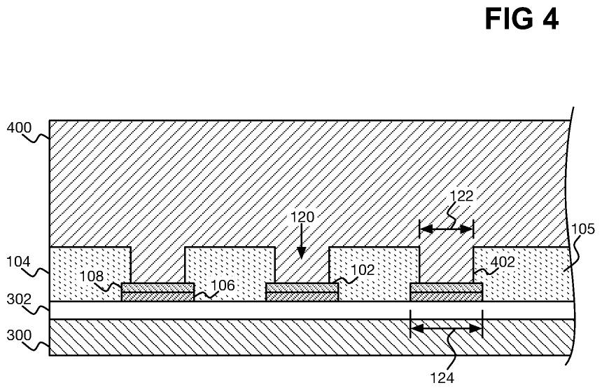

FIG. 4 shows a cross-sectional front view of example overmolding of molding compound 105 around printhead dies 102 with their nozzle layers 106 against the release tape 302 of the carrier 300. A mold chase 400 having slot feature inserts 402 has been moved downwards until the slot feature inserts 402 are forcibly clamped against the device layers 108 of the dies 102. The width of each slot feature insert 402 is the maximal width 122, such as between 70-90-F % of the width 124 of each die 102. Molding compound 105 has then been overmolded around the dies 102.

Therefore, the maximal width 122 of each slot 120 of the panel 104 is defined by (i.e., corresponds to) the width of each slot feature insert 402. By having such wide slot feature inserts 402, the inserts 402 are less likely to tilt the printhead dies 102 in the carrier 300 when forcibly clamped to the dies 102. Therefore, from a fabrication perspective, widening the slot feature inserts 402 to a maximal width 122 is the reason why the slots 120 are so wide.

However, from a device perspective—i.e., even if potential die tilt were not an issue—having wide slots 120 can itself be beneficial. Wide slots 120 can improve fluid circulation as fluid is supplied to the printhead dies 102. Wide slots 120 can decrease the likelihood that air or other gas becomes trapped within the slots 120, which would otherwise prevent fluid from reaching the dies 102 and result in improper die functioning. Wide slots 120 further provide a greater margin against misalignment of the slots 120 relative to the dies 102 by reducing the likelihood that the fluid channels 116 and 118 are partially or completely blocked by molding compound 105 of the panel 104, which would impede or prevent fluid from entering the channels 116 and 118.

In the depicted example, the slot feature inserts 402 and thus the slots 120 are rectangular in profile. However, the width of each insert 402 may instead widen from the maximal width 122 where it clamps against a corresponding printhead die 102 to a greater width at the top. In this case, the slots 120 are likewise trapezoidal in profile, and each has the maximal width 122 at the point where it is adjacent to a corresponding die 102. The corners of the inserts 402 and therefore of the slots 120 may also be rounded at a radius instead of being sharp corners as depicted.

Referring back to FIG. 2, once the molding compound 105 has been overmolded around the printhead dies 102, the mold chase 400 is moved upwards away from the carrier 300 so that the slot feature inserts 402 are no longer clamped against the dies 102 (208). The printhead dies 102 are debonded from the release tape 302 of the carrier 300 (210). The panels 104 of adjacent printheads 100 at this stage are contiguous one another, and therefore are segmented from one another in correspondence with the individual printheads 100 to be formed (212).

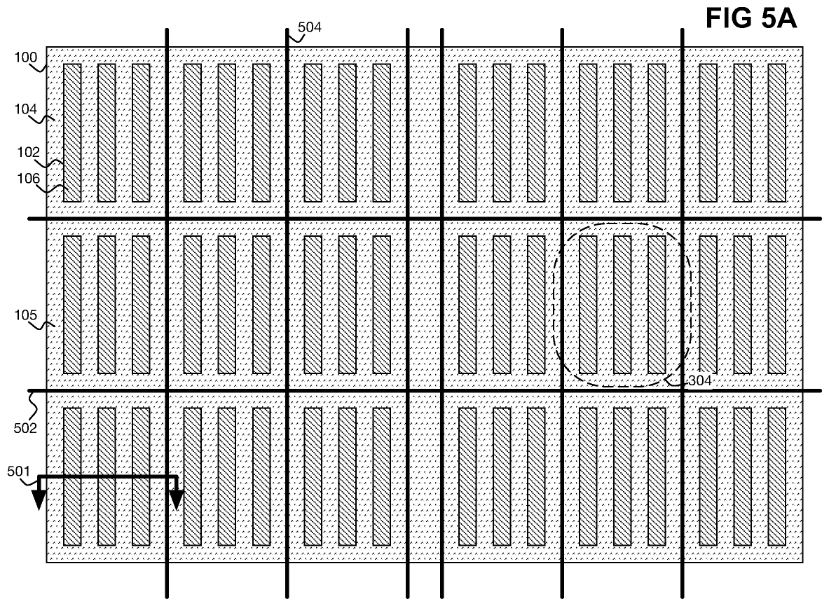

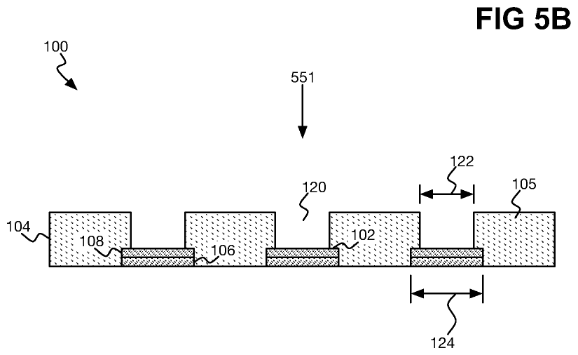

FIG. 5A shows a top view of example printheads 100 after the printhead dies 102 have been removed from the carrier 300 but prior to segmentation into individual printheads 100, and FIG. 5B shows a cross-sectional front view of one such printhead 100 after segmentation. The cross-sectional view of FIG. 5B is at the cross-sectional line 501 in FIG. 5A. The top view of FIG. 5A is indicated by the arrow 551 in FIG. 5B.

The contiguous panels 104 are segmented in groups 304 of three printhead dies 102, at the horizontal segmentation lines 502 and at the vertical segmentation lines 504 (per FIG. 5A). Stated another way, the contiguous panels 104 are segmented in correspondence with the individual printheads 100 to be formed. In the depicted example, a total of eighteen printheads 100 are formed.

Each individual printhead 100 (per FIG. 5B) thus includes three printhead dies 102, as well as a panel 104 that for each die 102 has a corresponding wide slot 120 at a maximal width 122 which may be between 70-100-F % of the die width 124. The device layer 108 of each die 102 is adjacent to a corresponding slot 120. By comparison, the nozzle layer 106 of each die 102 can be flush with an opposing exterior surface of the panel 104.

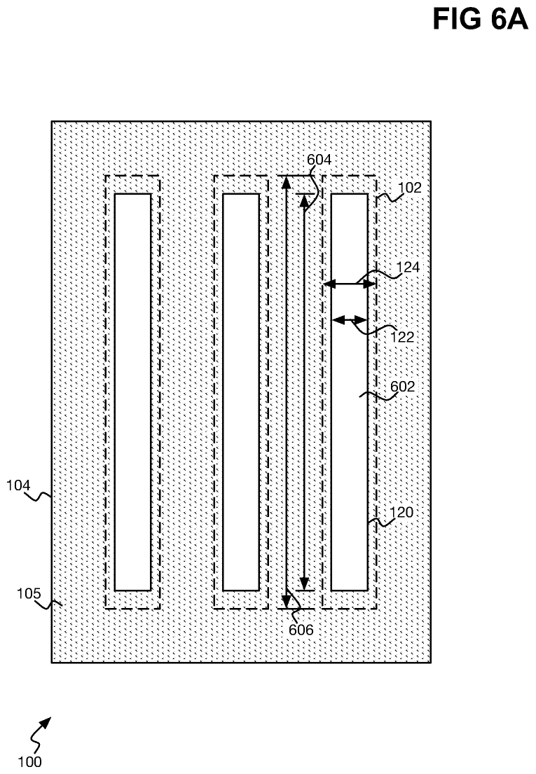

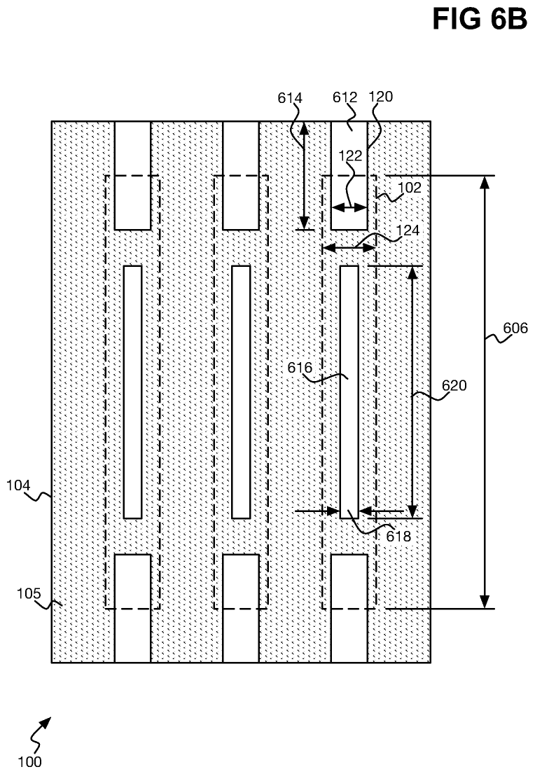

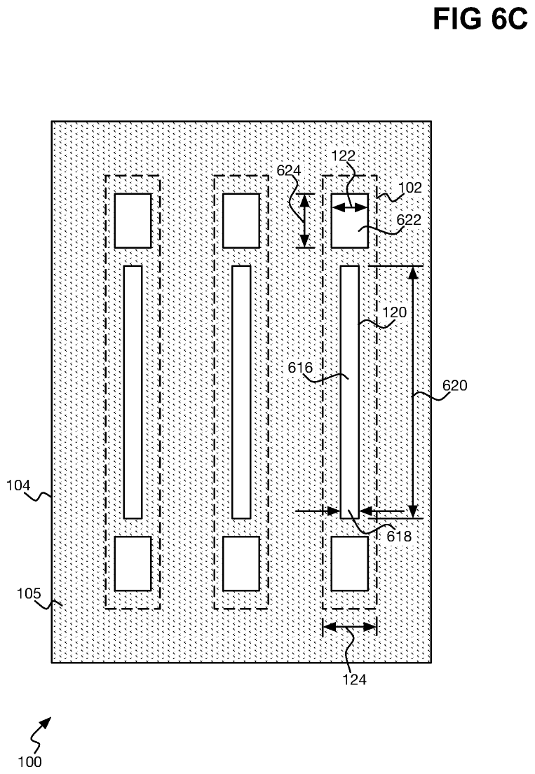

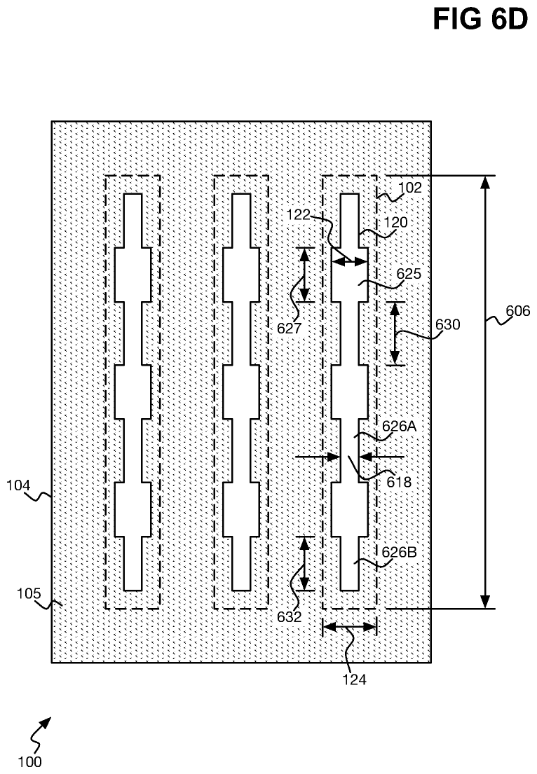

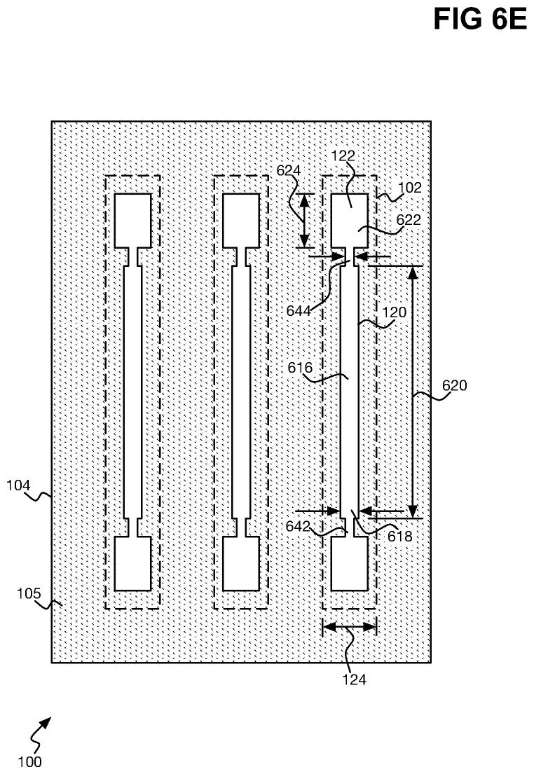

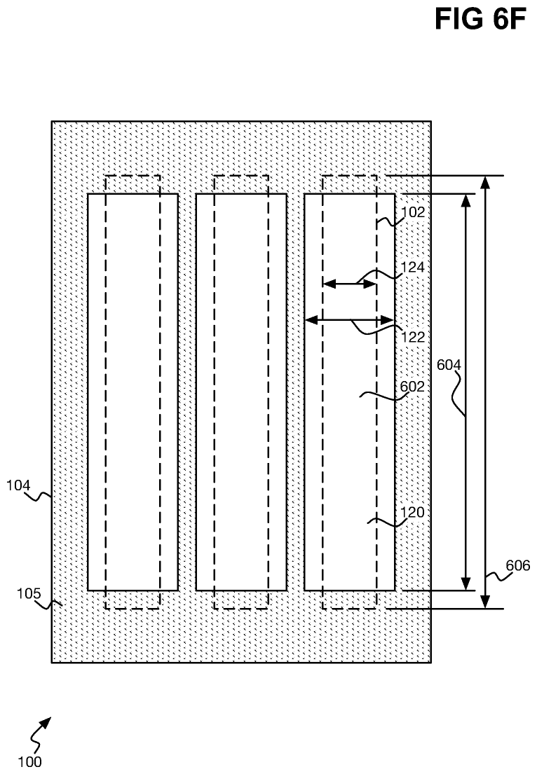

FIGS. 6A, 6B, 6C, 6D, 6E, and 6F show top views of different example configurations of wide slots 120 of a printhead 100. In all four examples, the printhead 100 has three printhead dies 102 at locations indicated by dotted lines, and three slots 120 corresponding to the dies 102. The molded panel 104 of the printhead 100 is fabricated from molding compound 105, as has been described. The figures are not necessarily drawn to scale.

In FIG. 6A, each slot 120 has a single slot portion 602 that has the maximal width 122 across its entire length 604. Each slot 120 is thus rectangular, but may have rounded instead of sharp corners as depicted, and/or may be oval in shape or have another shape. The maximal width 122 may be 370 microns, and the length 604 may be 17.890 millimeters. The width 124 of each printhead die 102 may be 406 microns, such that the maximal width 122 of each slot 120 is nearly 93% of die width 124. Each die 102 is also longer than each slot 120, and may have a length 606 equal to 19.690 millimeters.

In FIG. 6B, each slot 120 has a primary slot portion 616 and one or multiple secondary slot portions 612. Each secondary slot portion 612 is at an end of the primary slot portion 616, and is further open at an end of the panel 104. Each secondary slot portion 612 is fluidically isolated from the primary slot portion 616, in that molding compound 105 separates each secondary slot portion 612 from the primary slot portion 616.

Just the secondary slot portions 612, and not the primary slot portion 616, each have the maximal width 122 of the slot 120, such as 370 microns. In another implementation, the maximal width 122 of each secondary slot portion 612 may be 100+% of the die width 124, such as 406 microns. The width 618 of the primary slot portion 616 is narrower, and may be 165 microns. Each secondary slot portion 612 may have a length 614 of 596 microns, and the length 620 of the primary slot portion 616 may be 16.000 mm. The length 606 of each printhead die 102 may be 19.690 millimeters as before.

As depicted, the slot portions 612 and 616 are each rectangular. However, the ends of the secondary slot portions 612 closer to the primary slot portion 616 may instead be rounded, and the corners of the primary slot portion 616 may be rounded instead of sharp as depicted. Furthermore, just the primary slot portion 616, and not either secondary slot portion 612, is fluidically coupled to the device layer 108 of a corresponding printhead die 102.

Therefore, it is the secondary slot portions 612 of the slots 120, and not the primary slot portion 616, that impedes tilting of the printhead dies 102 by the slot feature inserts 402 of the mold chase 400 during formation of the overmolded panel 104. By comparison, during usage of the printhead 100, it is just the primary slot portion 616, and not either secondary slot portion 612, that provides fluid to the device layer 108 for ejection.

Having a narrower and shorter primary slot portion 616 in FIG. 6B (as compared to the single slot portion 602 in FIG. 6A) can ensure that the channels 116 and 118 in the device layer 108 remain unblocked during usage of the printhead 100. Having a narrower and shorter primary slot portion 616 can also provide for better thermal management of fluid at the ends of the slot portion 616 (as compared to at the ends of the single slot portion 602 in FIG. 6A). Having the secondary slot portions 612 open at the ends of the panel 104 can impede trapping of air during the overmolding process.

In FIG. 6C, similarly, each slot 120 has the primary slot portion 616 and one or multiple secondary slot portions 622. Each secondary slot portion 622 is again at an end of the primary slot portion 616, but is closed at an end of the panel 104 (instead of being open, as each secondary slot portion 612 is in FIG. 6B). Each secondary slot portion 622 is again fluidically isolated from the primary slot portion 616.

Just the secondary slot portions 622, and not the primary slot portion 616, each have the maximal width 122 of the slot 120, such as 370 microns as in FIG. 6A, as before. The maximal width 122 of each secondary slot portion 622 may instead be equal to 100% of the die width 124, or 406 microns. The width 618 of the primary slot portion 616 is narrower, and may be 165 microns as in FIG. 6B. Each secondary slot portion 622 may have a length 624 of 570 microns, and the length 620 of the primary slot portion 616 may be 16.000 mm as in FIG. 6B. The length 606 of each printhead die 102 may be 19.690 millimeters as before.

As depicted, the slot portions 616 and 622 are each rectangular. However, the corners of each slot portion 616 and 622 may be rounded instead of sharp as depicted. Furthermore, just the primary slot portion 616, and not either secondary slot portion 612, is fluidically coupled to the device layer 108 of a corresponding printhead die 102, similar to as in FIG. 6B.

Therefore, it is the secondary slot portions 622 of the slots 120, and not the primary slot portion 616, that impedes tilting of the printhead dies 102 by the slot feature inserts 402 of the mold chase 400 during formation of the overmolded panel 104, similar to as in FIG. 6B. By comparison, during usage of the printhead 100, it is just the primary slot portion 616, and not either secondary slot portion 622, that provides fluid to the device layer 108 for ejection, also similar to as in FIG. 6B.

Having a narrower and shorter primary slot portion 616 can thus provide the same benefits as described above in relation to FIG. 6B. Having the secondary slot portions 622 closed (instead of open) at the ends of the panel 104, however, minimizes potential interaction with adjacent panels 104 during the overmolding process, and further fully encapsulates ends of a corresponding printhead die 102, which can improve reliability of the die 102.

In FIG. 6D, each slot 120 has one or multiple wide slot portions 625 and one or multiple narrow slot portions 626A and 626B. In the example, there are two inner narrow slot portions 626A, two outer slot portions 626B, and three wide slot portions 625 that are each between an outer narrow slot portion 626B and an inner narrow slot portions 626A. The slot portions 625, 626A, and 626B, are not fluidically isolated from one another.

Just the wide slot portions 625 have the maximal width 122 of the slot 120, such as 370 microns as in FIG. 6A, or in another implementation 406 microns (or otherwise equal to the die width 124). The width 618 of each narrow slot portion 626A and 626B may be 165 microns, similar to as in FIGS. 6B and 6C. The length 627 of each wide slot portion 625 may be 535 microns. The length 630 of each inner narrow slot portion 626A may be 5.025 millimeters, and the length 632 of each outer narrow slot portion 626B may be 2.560 millimeters. The length 606 of each printhead die 102 may be 19.690 millimeters as before.

As depicted, the slot portions 625, 626A, and 626B are each rectangular, but may instead have rounded corners. Because the slot portions 625, 626A, and 626B are not fluidically isolated from one another, during usage of the printhead 100, all the slot portions 625, 626A, and 62B provide, to some degree, fluid to the device layer 108 for ejection. However, just the wide slot portions 625 impede tilting of the printhead dies 102 during formation of the overmolded panel 104.

Having multiple fluidically contiguous slot portions 625, 626A, and 626B of varying widths in each slot 120 can reduce fragility issues during the overmolding process, and ensure that stress is more evenly distributed across the printhead dies 102. The density, distribution, number, and configuration of the slot portions 625, 626A, and 626B can be varied as dictated by usage specifications of the printhead 100. Having narrow slot portions 626A and 626B in addition to wide slot portions 625 (i.e., as opposed to having a single slot portion 602 that is wide as in FIG. 6A) further provides a greater surface area for adhesion of the panel 104 to the printhead dies 102 during overmolding.

In FIG. 6E, similar to as in FIG. 6C, each slot 120 has the primary slot portion 616 and one or multiple secondary slot portions 622. Each secondary slot portion 622 is again at an end of the primary slot portion 616, and is closed at an end of the panel 104 as in FIG. 6C. However, the secondary slot portions 622 are not fluidically isolated from the primary slot portion 616, unlike in FIG. 6C, but instead are fluidically connected or coupled to the primary slot portion 616 via narrow slot portions 642.

Just the secondary slot portions 622, and not the primary slot portion 616 or the narrow slot portions 642, each have the maximal width 122 of the slot 120, such as 370 microns. The maximal width 122 of each secondary slot portion 622 may instead be equal to 100% of the die width 124, or 406 microns. The width 618 of the primary slot portion 616 is narrower, and may be 165 microns. The width 644 of each narrow slot portion 642 is even narrower, and may be as narrow as is manufacturably viable. Each secondary slot portion 622 may have a length 624 of 570 microns, and the length 620 of the primary slot portion 616 may be 16.000 mm as in FIG. 6B. The length 606 of each printhead die 102 may be 19.690 millimeters as before.

As depicted, the slot portions 616, 622, and 642 are each rectangular. However, the corners of each slot portion 616, 622, and 642 may be rounded instead of sharp as depicted. It is the secondary slot portions 622 of the slots 120, and not the primary slot portion 616 or the narrow slot portions 642, that impedes tilting of the printhead dies 102 by the slot feature inserts 402 of the mold chase 400 during formation of the overmolded panel 104, similar to as in FIG. 6B.

Having a narrower and shorter primary slot portion 616 can thus provide the same benefits as described above in relation to FIG. 6B. Having the secondary slot portions 622 closed (instead of open) at the ends of the panel 104 provide the same benefits as described above in relation to FIG. 6C.

The narrow slot portions 642 act as small fluidic bridges between the secondary slot portions 622 and the primary slot portion 616. However, in actual operation fluid motion between the secondary slot portions 622 and the primary slot portion 616 via the narrow slot portions 642 is minimal. Having such small fluidic bridges (i.e., the narrow slot portions 642), though, can isolate fluid from active eureka structures at ends of the printhead die 102 so that any bubbles that form do not interact with the channels 116 and 118.

In FIG. 6F, each slot 120 has a single slot portion 602 that has the maximal width 122 across its entire length 604. Each slot 120 is thus rectangular, but may have rounded instead of sharp corners as depicted, and/or may be oval in shape or have another shape. The maximal width 122 may be 600 microns, and the length 604 may be 17.890 millimeters. The width 124 of each printhead die 102 may be 406 microns, such that the maximal width 122 of each slot 120 is greater than the die width 124 and nearly 150% of die width 124. Each die 102 is also longer than each slot 120, and may have a length 606 equal to 19.690 millimeters.

A benefit of having slots 120 that have a maximal width 122 wider than the width 124 of the printhead dies 102 is ensuring that the dies 102 remain free from molding compound adjacent to the slots 120 so that subsequent processes have access to this surface. Another benefit is an increased maximum allowable offset between the slots 120 and the dies 102 such that both tilt and occlusion of channels 116 and 118 due to the molding compound 105 can be controlled, which permits manufacturing controls (e.g., tolerances) to be loosened.

Techniques have been described for impeding printhead die tilting during panel overmolding. By having wider slot feature inserts 402 within the molding chase 400, the inserts 402 are less likely to tilt the printhead dies 102 to which they are forcibly clamped. As a result, the formed slots 120 within the panel 104 accordingly each have a wider maximal width 122.

We claim:

1. A printhead comprising:
one or multiple printhead dies that are each to eject a corresponding type of fluid; and
an overmolded panel around the printhead dies and having one or multiple wide slots respectively corresponding to the printhead dies, each wide slot to supply fluid of the corresponding type to the printhead die to which the wide slot corresponds.

2. The printhead of claim 1, wherein the wide slots are wide in that each wide slot has a maximal width that is greater than 70% of a width of each printhead die.

3. The printhead of claim 2, wherein the maximal width of each wide slot is greater than 100% of the width of each printhead die.

4. The printhead of claim 1, wherein each wide slot has a maximal width and has a single slot portion having the maximal width across a length of the single slot portion.

5. The printhead of claim 1, wherein each wide slot has a maximal width and has a primary slot portion and one or multiple secondary slot portions that are each at an end of the primary slot portion,
wherein the primary slot portion but not any secondary slot portion is to supply the fluid to the printhead die to which the wide slot corresponds,
wherein each secondary slot portion has the maximal width across a length of the secondary slot portion,
and wherein the primary slot portion has a width less than the maximal width across a length of the primary slot portion.

6. The printhead of claim 5, wherein each secondary slot portion is open at an end of the overmolded panel,
and wherein the primary slot portion is fluidically isolated from the secondary slot portions.

7. The printhead of claim 5, wherein each secondary slot portion is closed at an end of the overmolded panel.

8. The printhead of claim 7, wherein each secondary slot portion is fluidically isolated from the primary slot portion.

9. The printhead of claim 7, wherein secondary slot portion is fluidically coupled to the primary slot portion via a fluidic bridge.

10. The printhead of claim 1, wherein each wide slot has a maximal width and has one or multiple wide slot portions and one or multiple narrow slot portion,
wherein each wide slot portion and each narrow slot portion are to supply the fluid to the printhead die to which the wide slot corresponds,
wherein the wide slot portions are not fluidically isolated from the narrow slot portions,
wherein the wide slot portions are wide in that each wide slot portion has the maximal width across a length of the wide slot portion,
and wherein the narrow slot portions are narrow in that each narrow slot portion has a width less than the maximal width across a length of the narrow slot portion.

11. The printhead of claim 1, wherein the multiple wide slots comprise either:
at least three wide slots respectively corresponding to different fluid colors; or
a single wide slot corresponding to a single fluid color.

12. An overmolded panel of a printhead for one or multiple printhead dies of the printhead that are each to eject a corresponding type of fluid, the overmolded panel comprising:
an overmolded compound around the printhead die and defining one or multiple wide slots respectively corresponding to the printhead dies, each wide slot to supply fluid of the corresponding type to the printhead die to which the wide slot corresponds.

13. The overmolded panel of claim 12, wherein the wide slots are wide in that each wide slot has a maximal width that is greater than 70% of a width of each printhead die.

14. The overmolded panel of claim 13, wherein each wide slot has a single slot portion having the maximal width across a length of the single slot portion.

15. The overmolded panel of claim 13, wherein each wide slot has a primary slot portion and one or multiple secondary slot portions that are each at an end of the primary slot portion,
wherein the primary slot portion but not any secondary slot portion is to supply the fluid to the printhead die to which the wide slot corresponds,
wherein the primary slot portion is fluidically isolated from the secondary slot portions,
wherein each secondary slot portion has the maximal width across a length of the secondary slot portion,
wherein the primary slot portion has a width less than the maximal width across a length of the primary slot portion,
and wherein each secondary slot portion is open at an end of the overmolded panel.

16. The overmolded panel of claim 13, wherein each wide slot has a primary slot portion and one or multiple secondary slot portions that are each at an end of the primary slot portion,
wherein the primary slot portion but not any secondary slot portion is to supply the fluid to the printhead die to which the wide slot corresponds,
wherein each secondary slot portion has the maximal width across a length of the secondary slot portion,
wherein the primary slot portion has a width less than the maximal width across a length of the primary slot portion,
and wherein each secondary slot portion is closed at an end of the overmolded panel.

17. The overmolded panel of claim 13, wherein each wide slot has one or multiple wide slot portions and one or multiple narrow slot portion,
wherein each wide slot portion and each narrow slot portion are to supply the fluid to the printhead die to which the wide slot corresponds,
wherein the wide slot portions are not fluidically isolated from the narrow slot portions,
wherein the wide slot portions are wide in that each wide slot portion has the maximal width across a length of the wide slot portion,
and wherein the narrow slot portions are narrow in that each narrow slot portion has a width less than the maximal width across a length of the narrow slot portion.

18. A method comprising:
moving a mold chase having a slot feature insert downwards towards a carrier populated with a plurality of printhead dies until the slot feature insert is forcibly clamped against the printhead dies; and
while the slot feature insert of the mold chase is forcibly positioned against the printhead dies, overmolding a molding compound around the printhead dies to form panels around the printhead dies having wide slots defined by the slot feature insert and that correspond to the printhead dies.

19. The method of claim 18, wherein the wide slots are wide in that each wide slot has a maximal width that is greater than 70% of a width of each printhead die.

20. The method of claim 18, further comprising:
moving the mold chase upwards from the carrier so that the slot feature insert is no longer clamped against the printhead dies;
debonding the printhead dies around which the panels have been formed from the carrier; and
segmenting the panels from one another in correspondence with individual printheads, where each individual printhead includes one of the panels and one or multiple of the printhead dies.
